(19) United States
(12) Patent Application Publication
(10) Pub. No.: US 2023/0310277 A1
(43) Pub. Date: Oct. 5, 2023

(54) VIAL ADAPTOR WITH VALVE

(71) Applicant: Teva Pharmaceuticals International GmbH, Rapperswil-Jona (CH)

(72) Inventor: Ivan Jurilj, Zapresic (HR)

(73) Assignee: Teva Pharmaceuticals International GmbH, Rapperswil-Jona (CH)

(21) Appl. No.: 18/023,408

(22) PCT Filed: Sep. 1, 2021
(86) PCT No.: PCT/EP2021/074107

§ 371 Date: Feb. 27, 2023

(30) Foreign Application Priority Data
Sep. 3, 2020 (EP) 20194465.9

(51) Int. Cl. A61J 1/20

(52) U.S. Cl. CPC A61J 1/2096; A61J 1/201; A61J 1/2037; A61J 1/2086; A61J 1/2051

(57) ABSTRACT

The invention relates to a vial adaptor. The vial adaptor comprises a syringe connection port. The syringe connection port is configured to be connected to a syringe. The vial adaptor further comprises a vial connection port. The vial connection port comprises a skirt and a spike. The spike has a lumen forming a fluid channel. The vial adaptor further comprises a conduit configured to provide fluid flow between the syringe connection port and the vial connection port. The vial adaptor further comprises a valve for selectively blocking and allowing fluid flow between the syringe and the conduit through the syringe connection port when the syringe is connected to the syringe connection port. This constitutes an improved solution for connecting a syringe and a vial.

### CROSS REFERENCE TO RELATED APPLICATION

This application claims the benefit of European patent application no. 20194465.9, filed Sep. 3, 2020, the entirety of which is incorporated by reference herein.

### TECHNICAL FIELD

The disclosure relates to the field of devices and methods used for handling and manipulating fluids in a medical context, and more particularly, to a vial adaptor and a method of use thereof.

### BACKGROUND

In a medical context, connection between a syringe containing a medical substance and a vial containing another medical substance is often required, for example in order to mix the two substances in the vial. This operation is often referred to as “reconstitution”. The reconstitution results in a solution or suspension which can be withdrawn for, for example, injection to a patient or addition to an intravenous drip bag. Such withdrawal and injection (or addition) may be performed using the same syringe. Existing solutions for connecting the syringe to the vial include different vial-syringe connection devices such as syringe adaptors and vial adaptors.

Within this context, there is a need for an improved solution for connecting a vial and a syringe.

### SUMMARY

It is therefore provided a vial adaptor. The vial adaptor comprises a syringe connection port. The syringe connection port is configured to be connected to a syringe. The vial adaptor further comprises a vial connection port. The vial adaptor comprises a skirt and a spike. The spike has a lumen forming a fluid channel. The vial adaptor further comprises a conduit configured to provide fluid flow between the syringe connection port and the vial connection port. The vial adaptor further comprises a valve for selectively blocking and allowing fluid flow between the syringe and the conduit through the syringe connection port when the syringe is connected to the syringe connection port.

In examples, the vial adaptor may comprise any one or any combination of the following features:
the syringe connection port and the vial connection port are arranged on opposite sides of the vial adaptor, and/or the conduit is linear and/or straight;
the valve comprises a valve body and a fluid passageway formed in the valve body, the valve being operable between a first position in which the fluid passageway is aligned with the conduit and allows fluid flow, and a second position in which the valve body blocks fluid flow;
the valve is movable in rotation between the first position and the second position, and/or the fluid passageway formed in the valve body has a diameter smaller than a diameter of the conduit;
the valve comprises a handle for manually operating the valve between the first position and the second position, the handle being optionally integrally formed with the valve body;
the valve is operable between the first position and the second position independent of a syringe being connected to the syringe connection port;
the vial adaptor further comprises a casing portion, the valve body being arranged in the casing portion, wherein optionally the casing portion has a cylindrical shape, the valve body having a cylindrical shape complementary to the cylindrical shape of the casing portion, the valve body being movable in rotation between the first position and the second position around a longitudinal axis of the casing portion;
the longitudinal axis of the casing portion is substantially orthogonal to a vial connection axis of the vial adaptor defined between the syringe connection port and the vial connection port;
the vial adaptor comprises a first conduit portion in fluid communication with the syringe connection port, a second conduit portion in fluid communication with the vial connection port, the casing portion being arranged between the first conduit portion and the second conduit portion;
the syringe connection port, the first conduit portion, the casing portion and the second conduit portion are integrally formed;
the skirt and the spike are integrally formed with the second conduit portion, or the skirt and the spike are releasably connected to the second conduit portion;
the vial adaptor is configured for releasable connection to a syringe or to a syringe adaptor, the syringe connection port optionally comprising a luer lock; and/or
the vial adaptor is manufactured from a material resistant to an aggressive solvent.

Further provided is a method of use of the vial adaptor. The method of use comprises providing a vial containing a drug, e.g. an active pharmaceutical ingredient (API) and optionally one or more excipient and a syringe comprising a reconstitution fluid. The API and reconstitution fluid are preferably kept apart until administration is desired. The reconstitution fluid may comprise a solvent and/or a vehicle. The syringe may additionally or alternatively comprise a drug, e.g. a drug different from the drug contained in the vial. The method of use further comprises connecting the vial adaptor to the vial. The method of use further comprises connecting the syringe to the vial adaptor. The method of use further comprises selectively blocking and allowing fluid flow between the syringe and the vial by operation of the syringe and operation of the valve.

In examples, the method of use may comprise any one or any combination of the following features:
the selective blocking and allowing of fluid flow between the syringe and the vial comprises:
   dispensing reconstitution fluid from the syringe inside the vial for reconstitution of a solution or suspension inside the vial, the valve allowing fluid flow during the dispensing; and
   operating the valve to block fluid flow after the dispensing;
after the operating to block fluid flow, manually agitating the vial;
after reconstitution:
   operating the valve to allow fluid flow; and
   withdrawing the reconstituted solution inside the vial with the syringe or with another syringe; and/or
after the withdrawing:
   disconnecting the syringe or the other syringe from the vial adaptor; and
   performing an injection of the reconstituted solution with the syringe or the other syringe, the injection being optionally a subcutaneous injection into a mammal, for example a human.

Yet further provided is a kit. The kit comprises the vial adaptor. The kit may comprise a vial containing a drug. The kit may comprise a syringe comprising a reconstitution fluid. The syringe is capable of cooperating with the vial adaptor. The reconstitution fluid may comprise a solvent and/or a vehicle. The syringe may additionally or alternatively comprise a drug, e.g. a drug different from the drug contained in the vial. The kit may optionally comprise a syringe adaptor and/or a needle for injection. The syringe adaptor may be configured to cooperate with the vial adaptor. The syringe adaptor may for example be configured to be connected to the syringe connection port of the vial adaptor. The syringe may enable fluid mixing. The kit may additionally or alternatively comprise instructions for a user. The syringe in the kit may contain a solvent with which to reconstitute the API. The syringe in the kit may contain a polymer with which to reconstitute the API. The syringe may include both a solvent and a polymer solution with which to reconstitute the API. In some embodiments the solvent is an aqueous solvent or a non-aqueous solvent. In some embodiments the solvent is dimethyl sulfoxide (DMSO). The vial may contain (e.g. only) an API in powder or crystalline form. In some embodiments the API is olanzapine powder. The kit may optionally further comprise another syringe for performing an injection. Said other syringe may be operable for withdrawing a reconstituted solution inside the vial. A “reconstituted solution” as used herein, refers to a reconstituted solution or a reconstituted suspension.

### BRIEF DESCRIPTION OF THE DRAWINGS

Non-limiting examples will now be described in reference to the accompanying drawings, where:

FIG. 1 illustrates a schematic cross-section of a vial adaptor according to an embodiment of the present disclosures, with a valve in a first position;

FIG. 2 illustrates a schematic cross-section of the vial adaptor of FIG. 1, with the valve in a second position;

FIG. 3 illustrates a portion of the vial adaptor of FIG. 1;

FIG. 4 illustrates a step in a method of using a vial adaptor according to an embodiment of the present disclosure;

FIG. 5 illustrates a step in a method of using the vial adaptor after the step shown in FIG. 4;

FIG. 6 illustrates a step in a method of using the vial adaptor after the step shown in FIG. 5;

FIG. 7 illustrates a step in a method of using the vial adaptor after the step shown in FIG. 6;

FIG. 8 illustrates a step in a method of using the vial adaptor after the step shown in FIG. 7; and

FIG. 9 illustrates a schematic of a kit according to an embodiment of the current disclosure.

### DETAILED DESCRIPTION

It is provided a vial adaptor which comprises a syringe connection port and a vial connection port. The syringe connection port is configured to be connected to a syringe. The vial connection port comprises a skirt and a spike, the spike having a lumen forming a fluid channel. The vial adaptor further comprises a conduit configured to provide fluid flow between the syringe connection port and the vial connection port, and a valve for selectively blocking and allowing fluid flow between the syringe and the conduit through the syringe connection port when the syringe is connected to the syringe connection port. The conduit may establish fluid flow between the lumen of the spike and the syringe connection port. The spike may be configured to puncture a seal of a vial. The skirt may be configured to provide attachment to the vial, the attachment being optionally irreversible. The skirt may for example include a mechanism to avoid detachment during manual agitation of the vial (e.g. shaking). The mechanism may include cantilever snap features configured to couple onto the vial collar/neck. The snap features may comprise three or more flexible tongues. This constitutes an improved solution for connecting a vial and a syringe.

Notably, the vial adaptor enables to selectively allow and block, thus to control, the flow of fluid between, on the one hand, a syringe connected to the vial adaptor, by means of the syringe connection port, and on the other hand, the conduit of the vial adaptor. In particular, the valve enables selectively blocking and allowing fluid flow through the syringe connection port. Thus, the vial adaptor allows flow regulation of fluid going out of the syringe and/or regulation of fluid entering the syringe, via the conduit and through the syringe connection port. This facilitates connection of a syringe to a vial via the vial adaptor, and/or any operation of the assembly after connection.

The valve is configured for selectively allowing fluid to flow through the syringe connection port and blocking such flow when the syringe is connected to the syringe connection port. The valve thus forms a stopcock that can seal tightly the conduit or not. This is of importance when dispensing the fluid from the syringe connected to the vial adaptor into a vial also connected to the vial adaptor, by means of the vial connection port, for reconstitution. Indeed, the valve may be arranged so that the space delimited by the valve, the portion of the conduit connecting the valve to the syringe connection port, and the syringe connection port and the syringe connected thereto, form a tightly sealed space. Likewise, the space delimited by the valve, the portion of the conduit connecting the valve to the vial connection port, and the vial connection port and the vial connected thereto, form a tightly sealed space. In other words, the valve is configured to separate the portion of the conduit connecting the valve to the vial connection port and the portion of the conduit connecting the valve to the syringe connection port. In such an arrangement, the valve prevents circulation of the fluid and/or of the reconstituted solution between the portions of the conduit separated by the valve. During operation of the assembly of the vial adaptor with the syringe and the vial, the valve prevents the fluid or the reconstituted solution from being withdrawn from the vial while reconstitution is not complete. In other words, the vial in such a case is a tightly sealed space where the reconstitution can occur safely, i.e. without risks of withdrawing, leakage and/or air entry/exit in the vial during the mixing. Furthermore, the dispensing may comprise operating the syringe by pushing a plunger of the syringe in a distal direction. The valve may in such a case be arranged to block fluid flow through the conduit, during reconstitution, which allows notably to avoid plunger push back in the syringe after the dispensing. In other words, the vial adaptor allows the plunger to be stable during reconstitution. This may also prevent accidental spraying or leakage of the reconstituted solution, for example, in a subsequent manual agitating (e.g. shaking) step of the reconstitution process upon disconnection of the syringe.

The valve may be operated manually for performing the selective allowing and blocking of fluid flow, i.e. the valve may be a manual valve. The valve may be located anywhere, for example in the conduit and downstream the syringe connection port. The valve may selectively block and allow fluid flow at the valve location, but such fluid flow control may be reverberated to the syringe connection port from distance. For example, the conduit portion that lies between the syringe connection port and the valve may be linear, i.e. this conduit portion may form a line that directly and continuously connects the syringe connection port to the valve, without any fork (bifurcation). Thereby, the valve selectively allows and blocks fluid flow at and through the syringe connection port from distance, by selectively allowing and blocking fluid flow at one end of the line.

The syringe connection port is a portion of the vial adaptor, said portion being configured for connection to a syringe, directly or indirectly (for example via a syringe adaptor). The connection may be releasable. The syringe connection port may comprise a connector, such as a luer lock connector or any other type of connector. The vial connection port is another portion of the vial adaptor, this portion being configured for connection to a vial. The connection to a vial may be releasable. The syringe connection port and the vial connection port will be further discussed hereinafter. The conduit is another portion of the vial adaptor, configured to provide fluid flow between the syringe connection port and the vial connection port.

During medical use of the vial adaptor, a syringe is connected to the vial adaptor by the syringe connection port. Likewise, the vial connection port is connected to a vial. During dispensing of a fluid, e.g. a reconstitution fluid, including for example a vehicle and/or a solvent, and the like, with the syringe, fluid contained in the syringe is to flow through the conduit to ultimately reach the vial, for reconstitution. Specifically, during dispensing, fluid within the syringe flows from the syringe through the syringe connection port, then through the conduit, then through the vial connection port, and ultimately into the vial. Conversely, after reconstitution, when withdrawn, the reconstituted solution flows from the vial through the vial connection port, then through the conduit, then through the syringe connection port, then into the syringe. The conduit enables such fluid flow, but the valve controls it, i.e. selectively allows it and blocks it.

The syringe connection port and the vial connection port may be arranged on opposite sides of the vial adaptor. The syringe connection port and the vial connection port thus form extremities of the conduit, and these extremities are located at opposite ends of the vial adaptor. This facilitates use of the vial adaptor, which thus has a generally straight direction of connection to vials and syringes, via the syringe connection port and the vial connection port.

Alternatively or additionally, the conduit may comprise only two apertures, that is, one toward the syringe connection port and one toward the vial connection port (i.e. no other aperture apart from these two apertures). In particular, the conduit may be linear. In other words, the conduit portion that lies between the syringe connection port and the valve and the conduit portion that lies between the vial connection port and the valve both form lines, i.e. passageways that continuously connect, respectively, on the one hand, the syringe connection port and the valve, and on the other hand, the valve and the vial connection port. In yet other words the conduit does not comprise any fork (bifurcation). This facilitates the selective blocking and allowing of fluid flow between the syringe connection port and the vial, as it allows to use a valve that selectively blocks and allows flow through a linear conduit. For example, the valve need not be configured for blocking or allowing flow at a fork portion of a conduit, as there is none. This also provides simplicity for manufacturing the vial adaptor. Additionally or alternatively, the conduit may be straight, i.e. the conduit may have a general straight tubular shape. For example, the conduit portion connecting the syringe connection port and the valve, and the conduit portion connecting the valve and the vial connection port may both form straight tubular shapes. This facilitates operation of the assembly of the vial adaptor with a syringe and a vial, the assembly being simple to hold and to manipulate. The conduit may additionally or alternatively comprise a filter. For example, the filter may include a first hydrophobic membrane having a pore size selected to prevent the passage of liquid there through. For example, a pore size of the first membrane may be of about 0.2 micron). The filter may additionally or alternatively include a second membrane configured to absorb liquid particles. Optionally, the second membrane may include a molecular sieve having pores sized to trap liquid particles. Optionally, the second membrane may comprise a desiccant. Optionally, the second membrane may comprise pores having a polar surface adapted to attract polar molecules. Such filter may be arranged anywhere in the conduit. The conduit may for example comprise a filter arranged in the conduit portion connecting the syringe connection port and the valve, and/or a filter arranged in the conduit portion connecting the valve and the vial connection port. The filter improves safety of operation.

The valve may be operated between a first position where the valve allows fluid flow through the syringe connection port and a second position where the valve blocks fluid flow through the syringe connection port. In other words, the valve may be selectively arranged into a first position where fluid can flow through the conduit and into a second position where fluid cannot flow through the conduit. In the second position, the valve, the conduit, the syringe connection port and the syringe connected thereto delimit a tightly sealed space. Likewise, in the second position, the valve, the conduit, the vial connection port and the vial connected thereto also delimit a tightly sealed space. In the second position, no fluid can be exchanged between the syringe connection port and the vial connection port through the conduit. The valve may be operable between the first position and the second position when a syringe is connected to the syringe connection port and/or when no syringe is connected to the syringe connection port. The operability of the valve between the first position and the second position may be independent from the connection of a syringe to the syringe connection port. In other words, the valve can be operated in the first position or in the second position whether there is a syringe connected to the syringe connection port or not.

The valve may comprise a valve body and a fluid passageway formed in the body. The valve body is formed from a material that contributes to achieve tightness of the fluid passageway: fluid flowing through the fluid passageway cannot escape from the fluid passageway, save from its extremities from which fluid goes into the syringe connection port or the vial connection port. The valve body may for example be formed in rubber, resin or polycarbonates, the valve body being for example injection-molded or 3-D printed. In the first position, the fluid passageway is aligned with the conduit and allows fluid flow through the conduit. In the second position, the fluid passageway is not aligned with the conduit and does not allow fluid flow through the conduit. The fluid passageway may for example be a linear and/or straight through hole traversing the valve body, the fluid passageway thus forming a tubular shape through the valve body and configured for alignment with the conduit. The fluid passageway may have a diameter smaller than the diameter of the conduit (i.e. the fluid passageway is narrower than the conduit), which improves tightness of the vial adaptor. The diameter of the fluid passageway may, for example, be strictly smaller than the diameter of the conduit. Alternatively, the diameter of the fluid passageway may be substantially equal to the diameter of the conduit.

The valve may be movable, for example by a user. The valve may be movable in rotation between the first position and the second position, e.g. the valve may be configured for being rotated by a user. The valve may notably comprise a handle for manually operating the valve between the first position and the second position. In other words, the user may rotate the handle between the first position and the second position, to selectively block and allow fluid flow through the conduit. This provides simplicity of use of the vial adaptor. The handle may be integrally formed with the valve body, the handle may be made in the same material as the valve body. The valve body may, for example, be injection-molded or 3-D printed. This provides simplicity of manufacturing. For example, the handle and the valve may be formed in a single injection-molding or 3-D printing process.

It is to be understood that, instead of the handle, the valve may comprise any other system suitable for being manually operated by a user in other to move the valve between a first position in which the fluid passageway is aligned with the conduit and allows fluid flow, and a second position in which the valve body blocks fluid flow.

The vial adaptor may further comprise a casing portion in which the valve body is arranged, the casing portion being a part of the vial adaptor. The arrangement of the valve body within the casing portion may be such that tightness of the fluid passageway and of its connection with the conduit is achieved. For example the dimensions of the valve body may substantially correspond to the dimensions of the casing portion, such that the valve body's shape is complementary to the shape of the casing portion. The handle may in this case form a handle-shaped protrusion of the valve body outside the casing portion. The casing portion may have a cylindrical shape, the valve body having then a cylindrical shape complementary to the cylindrical shape of the casing portion, the valve body being in such a case movable in rotation between the first position and the second position around a longitudinal axis of the casing portion. The longitudinal axis of the casing portion may be substantially orthogonal to a vial connection axis of the vial adaptor defined between the syringe connection port and the vial connection port.

The vial adaptor may comprise a first conduit portion in fluid communication with the syringe connection port and a second conduit portion in fluid communication with the vial connection port. The first conduit portion is a first portion of the conduit that is between the syringe connection port and the casing portion. The second conduit portion is a second portion of the conduit that is between the vial connection port and the casing portion. The casing portion is arranged between the first conduit portion and the second conduit portion. This improves simplicity of the mechanism of selectively allowing and blocking fluid flow provided by the rotatable valve.

The syringe connection port, the first conduit portion, the casing portion, and the second conduit portion may be integrally formed. The skirt and the spike may as well be integrally formed. The skirt and the spike may be integrally formed with the second conduit portion, and thus, also with the first conduit portion, the casing portion and the second conduit portion. This provides simplicity of manufacturing of the vial adaptor. Alternatively, the skirt and the spike may be releasably connected to the second conduit portion, for example threaded with the second conduit portion. This provides simplicity of manufacturing of the vial adaptor, as well.

For example, the vial adaptor may comprise a vial adaptor body including a first integrally-formed component and a second integrally-formed component. The first integrally-formed component may comprise or consist of the syringe connection port, the first conduit portion, the casing portion and the second conduit portion. The second integrally-formed component may include or consist of the vial connection port, including the skirt and the spike. The first integrally-formed component and the second integrally-formed component may be integrally-formed with each other, the vial adaptor body including in such a case a single integrally-formed component. Alternatively, the first integrally-formed component and the second integrally-formed component may be releasably connected to one another, for example threaded to one another. The integrally-formed components define the general shape of the vial adaptor body. The vial adaptor may include one or more elements separated from the vial adaptor body, such as the valve, the valve being for example inserted in the casing portion as previously discussed. Each integrally-formed component, or the single integrally-formed component where appropriate, may be molded, for example injection-molded, or 3-D printed. This facilitates manufacturing of the vial adaptor, as a single or only two injection-molding or 3-D printing processes may be required for forming the vial adaptor body. In any case, whether the vial adaptor body comprises a single integrally-formed component or more as previously discussed, in examples, all components and elements of the vial adaptor are fixedly attached (i.e. non detachable).

The vial adaptor body may present an elongate shape and may comprise or consists in sections that each extend along a (e.g. straight) central axis of the vial adaptor body, that may be the vial connection axis. For example, the syringe connection port may form a first extremity section of the vial adaptor body and the vial connection port may form a second extremity section of the vial adaptor body. The syringe connection port and the casing portion may be connected by a first conduit section that consists of the first conduit portion or, alternatively, that includes the first conduit portion, the first conduit portion being for example a through hole through the first conduit section. The vial connection port and the casing portion may be connected by a second conduit section that consists of the second conduit portion or, alternatively, that includes the second conduit portion, the second conduit portion being for example a through hole through the second conduit section. The casing portion may thus be a section of the vial adaptor body between the first conduit section and the second conduit section. One or more (e.g. all) sections of the vial adaptor body may present a generally prismatic (e.g. cylindrical) outer shape. Such examples of the vial adaptor body are relatively simple to manufacture and relatively compact. The vial adaptor body may be made of rigid and/or semi-rigid material, for example plastic. The vial adaptor body may be formed in a material configured for being in contact with aggressive solvents, for example dimethyl sulfoxide (DMSO). For example, the material may be polypropylene.

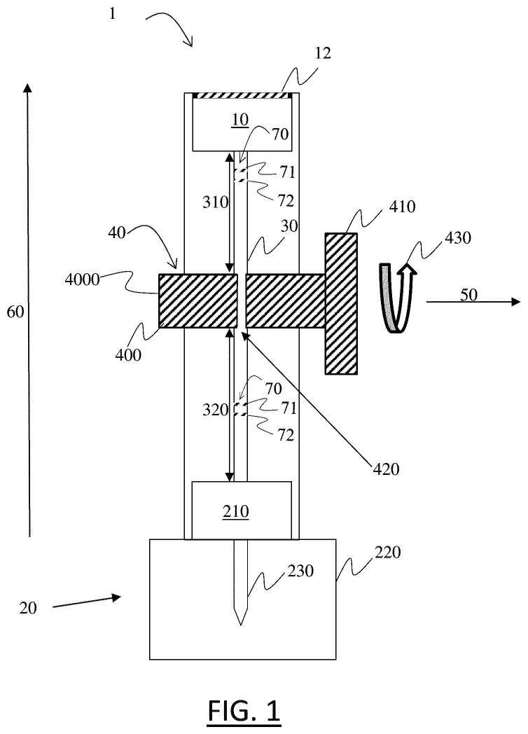

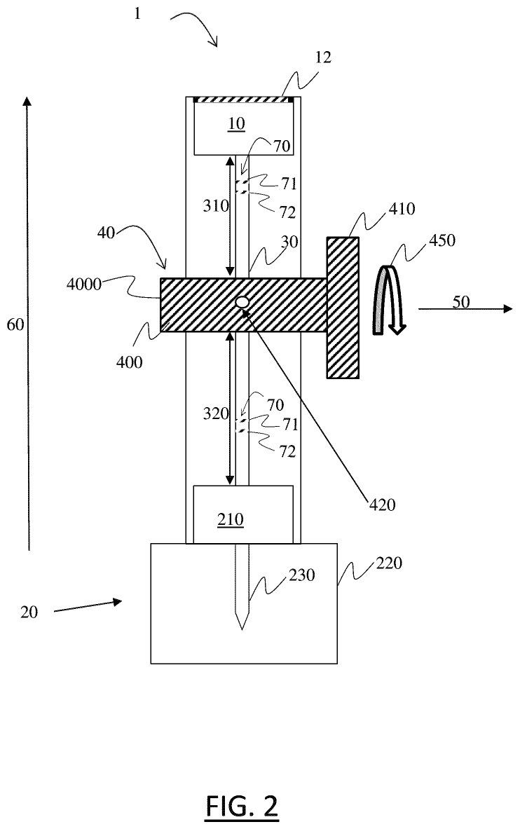

An example of the vial adaptor is now discussed with reference to FIGS. 1 and 2, which illustrate schematically a vial adaptor 1.

The vial adaptor 1 comprises a syringe connection port 10 configured to be connected to a syringe and a vial connection port 20 for connection of a vial. The vial connection port 20 comprises a skirt 220. The vial connection port 20 also comprises a spike 230 having a lumen (not shown on FIG. 1) forming a fluid channel. The vial adaptor 1 further comprises a conduit 30 configured to provide fluid flow between the syringe connection port 10 and the vial connection port 20. The conduit 30 is formed in the vial adaptor body. FIG. 1 does not show a specific shape of the vial adaptor body, but merely a schematic representation of the whole vial adaptor. The conduit 30 is configured to provide fluid flow, which means that the conduit 30 is configured for establishing or enabling fluid communication between the syringe connection port 10 and the vial connection port 20. The conduit 30 may in examples establish/enable fluid flow/communication between the lumen of the spike 230 (and/or a vial) and the syringe connection port 10. The spike 230 may be configured for puncturing a seal of the vial. The skirt 220 may be configured to provide attachment to the vial, the attachment being optionally irreversible. The skirt 220 may for example include a mechanism to avoid detachment of the vial during manual agitation of the vial (i.e. shaking). The mechanism may include cantilever snap features configured to couple onto a collar/neck of the vial. The snap features may comprise three or more flexible tongues. As shown in FIG. 1, the syringe connection port 10 and the vial connection port 20 are arranged on opposite sides of the vial adaptor, at opposite extremities of the conduit 30. In other words, the syringe connection port 10 and the vial connection port 20 form extremities of the conduit 30. The conduit 30 is linear and straight. The linear and straight general shape of the conduit gives a generally one-dimensional shape to the vial adaptor.

Still referring to FIGS. 1 and 2, the valve 40 is configured for blocking fluid flow through the syringe connection port 10. In other words, the valve 40 is configured for selectively allowing fluid to flow through the syringe connection port 10 and blocking such flow. The valve 40 shown in FIG. 1 is notably configured for being operated by a user between a first position where the valve 40 allows fluid flow through the syringe connection port 10 and a second position where the valve 40 blocks fluid flow through the syringe connection port 10. In other words, the valve is configured for being selectively arranged into the first position where fluid can flow through the conduit 30 and into the second position where fluid cannot flow through the conduit 30. FIG. 1 shows the vial adaptor 1 in the case where the valve 40 is in a configuration where fluid flow is allowed through the syringe connection port 10 (i.e. first position), and thus through the conduit 30. FIG. 2 shows the same vial adaptor 1, but in the case where the valve 40 is in a configuration wherein fluid flow through the syringe connection port 10 is blocked (i.e. second position).

As shown in FIGS. 1 and 2, the valve 40 comprises a valve body 400 and a fluid passageway 420 formed in the body 400. The valve 40 is operable between the first position shown in FIG. 1 in which the fluid passageway is aligned with the conduit 30 and allows fluid flow, and the second position shown in FIG. 2 in which the valve body 400 blocks fluid flow. The fluid passageway 420 is a through hole through the valve body 400. FIG. 1 only illustrates this through hole as a sectional longitudinal view, but it is to be noted that the through hole does not separate the valve body 400 into two distinct pieces. The first position is illustrated in FIG. 1, where the fluid passageway 420 and the conduit 30 are aligned. The second position is illustrated in FIG. 2, where the fluid passageway 420 and the conduit 30 are not aligned. The fluid passageway 420 has a diameter smaller than the diameter of the conduit 30.

The valve 40 shown in FIGS. 1 and 2 is movable in rotation between the first position and the second position. The valve 40 may be rotated a user. The valve 40 comprises a handle 410 for manually rotating the valve 40 between the first position and the second position, as shown in FIGS. 1 and 2. For operating the valve 40 from the first position shown in FIG. 1 and into the second position shown in FIG. 2, a user may typically rotate the handle 410 to move the valve 40 from the first position into the second position, for example according to the rotation direction 430. After this movement of the valve 40, the vial adaptor 1, originally in the first position illustrated in FIG. 1, now finds itself in the second position illustrated in FIG. 2. To move the valve 40 back into the first position, the user may then rotate the handle 410 to move the valve 40, for example according to rotation direction 450, which causes the valve 40 to return into the first position illustrated in FIG. 1. In FIG. 1 and FIG. 2, rotation directions 430 and 450 are opposite. However, this should not be construed as implying that movement from the first position to the second position can only be made by rotating the handle 410 according to rotation direction 430 and that movement from the second position back to the first position can only be made by rotating the handle 410 according to opposite rotation direction 450: in some examples it is the case, in other examples, both movement can be made according to a same rotation direction 430 or 450.

Still referring to FIGS. 1 and 2, the vial adaptor 1 further comprises a casing portion 4000, the valve body 400 being arranged in the casing portion 4000. The valve body 400 is arranged in the casing portion 4000 so as to achieve tightness, as previously discussed. The casing portion 4000 has a cylindrical shape, the valve body 400 having a cylindrical shape as well, the cylindrical shape of the valve body 400 being complementary to the cylindrical shape of the casing portion 4000, thus improving tightness. In such a case, the valve body 400 is movable in rotation between the first position shown in FIG. 1 and the second position shown in FIG. 2 around a longitudinal axis 50 of the casing portion 4000. As shown in FIGS. 1 and 2, the longitudinal axis 50 of the casing portion 4000 is substantially orthogonal to a vial connection axis 60 of the vial adaptor 1 defined between the syringe connection port 10 and the vial connection port 20.

As shown in FIGS. 1 and 2, the vial adaptor 1 comprises a first conduit portion (represented by arrow 310 in FIGS. 1 and 2) in fluid communication with the syringe connection port 10 and a second conduit portion (represented by arrow 320 in FIGS. 1 and 2) in fluid communication with the vial connection port 20. The casing portion 4000 is arranged between the first conduit portion 310 and the second conduit portion 320. In the first position represented by FIG. 1, during fluid dispensing, the fluid passageway 420 is aligned with the first conduit portion 310 and with the second conduit portion 320. In such an arrangement, fluid is dispensed from a syringe connected to the syringe connection port 10 into the syringe connection port 10, then through the first conduit portion 310, then through the fluid passageway 420, then into the vial connection port 20, and then, ultimately, into a vial connected to the vial connection port 20. After dispensing, the user rotates the handle 410 (e.g. according to rotation direction 430) so as to arrange the valve 410 into in the second position shown in FIG. 2, so that reconstitution may be done within the vial without risk of withdrawing (e.g. due to plunger push back) back into the vial adaptor 1 and/or the syringe. In this arrangement, the valve 40 blocks fluid flow through the conduit 30 as the fluid passageway 420 is not aligned with (e.g. is perpendicular to) the first conduit portion 310 and the second conduit portion 320. Thus, no fluid (or at least a significantly low amount of fluid) circulates in the first conduit portion 310 and in the syringe connection port 10, which means that the syringe's dispensing end is in a tightly sealed space, having no contact with outside air and/or an outside substance (e.g. substance within the vial). Once mixing in the vial is done, the user may rotate the handle 410 (e.g. according to rotation direction 450). Once this is done, the valve 400 is arranged back in the first position shown in FIG. 1, where the fluid passageway 420 is aligned with the first conduit portion 310 and with the second conduit portion 320. In such an arrangement, the syringe may be operated to withdraw the reconstituted solution in the vial into the syringe, the reconstituted solution flowing back through the vial connection port 20, then through the second conduit portion 320, then through the fluid passageway 420, then through the first conduit portion 310, then through the syringe connection port 10, and then ultimately in the syringe.

FIGS. 1 and 2 show a section 210 of the vial adaptor body between the second conduit portion 320 and the skirt 220. It is to be understood that the shape of section 210 as shown in these figures should not be considered as limitative, as the figures only show a schematic representation of the vial adaptor. Section 210 may be a section of the vial adaptor body that is threaded with the skirt 220, in examples where the skirt and the spike form an integrally-formed component threaded with the second conduit portion 320. In other words section 210 may be a lower extremity of the second conduit portion 320 that is threaded with the skirt 220. Alternatively, section 210 may simply be a part of the vial adaptor body forming an opening of the second conduit portion 320 in the skirt 230, the vial adaptor body being in such a case integrally formed.

The conduit 30 may additionally or alternatively comprise a filter 70. For example, the filter may include a first hydrophobic membrane 71 having a pore size selected to prevent the passage of particles there through. For example, a pore size of the first membrane 71 may be of about 0.2 micron). The filter 70 may additionally or alternatively include a second membrane 72 configured to absorb liquid particles. Optionally, the second membrane 72 may include a molecular sieve having pores sized to trap liquid particles. Optionally, the second membrane 72 may comprise a desiccant. Optionally, the second membrane 72 may comprise pores having a polar surface adapted to attract polar molecules. Such filter 71 may be arranged anywhere in the conduit 30. The conduit 30 may for example comprise a filter 70 arranged in the first conduit portion 310 connecting the syringe connection port 10 and the valve 40, and/or a filter 70 arranged in the second conduit portion 320 connecting the valve 40 and the vial connection port 40. The filter(s) 70 improves safety of operation. Though depicted as the same, it is contemplated that the filter 70 disposed in the first conduit portion 310 can be different than the filter 310 disposed in the second conduit portion 320.

The syringe connection port 10 and the vial connection port 20 are now further discussed.

The syringe connection port 10 is a structure of the vial adaptor 1 configured to be connected to a syringe, i.e. adapted for connection of a syringe (such as a luer fitted syringe) so as to allow fluid communication between the syringe and the vial via the conduit 30 upon operation of the syringe. The valve 40 selectively allows and blocks this fluid communication as previously discussed. The connection of the syringe to the syringe connection port 10 may be performed in an at least substantially airtight manner, such that there is no or only little leak to the outside and/or no or only little contamination from the outside when fluid communicates between the syringe and the vial. The syringe connection port 10 may be configured for an indirect connection and/or a direct connection. In an indirect connection case, the syringe is connected to the vial adaptor 1 via an intermediate component mounted on the vial adaptor 1, such as a syringe adaptor. In a direct connection case, the syringe directly accesses the vial adaptor 1 with no intermediate component. The same syringe connection port may be configured for both the direct type of connection and the indirect type of connection. The syringe connection port 10 may include a luer lock.

The syringe connection port 10 may, for example, comprise an opening formed on the vial adaptor body and define an upper extremity of the conduit 30 (relative to the vial adaptor 1 considered supported on a horizontal plane, as in FIGS. 1 and 2). The vial adaptor body may integrate a septum 12 which seals said upper extremity of the conduit 30. The vial adaptor body may comprise a casing which maintains firmly the septum 12 so as to close airtightly the upper extremity of the conduit 30. The septum 12 may for example comprise an elastomeric material. The elastomeric material may be configured for deforming when punctured by a hollow needle of the syringe adaptor or of the syringe in such a way that the hollow needle can pierce through the septum 12 and the elastomeric material forms a seal that is at least substantially airtight around the needle. The elastomeric material may be resilient, i.e. further configured for deforming back to its initial shape when the hollow needle is withdrawn, so as to again at least substantially seal the upper extremity of the conduit 30. The elastomeric material may for example comprise rubber, such as silicone rubber and/or butyl rubber. Alternatively or additionally, the vial adaptor body may comprise a detachable cap (not shown) which may be mounted on the syringe connection port 10 so as to close the upper extremity of the conduit 30. The detachable cap may in examples seal the upper extremity of the conduit 30. The detachable cap may be detached upon need to connect a syringe to the syringe connection port 10. The detachable cap may be fully removable or alternatively stay maintained to the syringe connection port 10 after detaching, for example via a hinge connecting the detachable cap to the vial adaptor 1.

In examples, the opening defining the upper extremity of the conduit 30 may be formed at the tip of a tubular member of the vial adaptor body. The interior of the tubular member may thereby constitute part of the conduit 30, for example a part of the first conduit portion 310. In examples, the tubular member may optionally be of a generally cylindrical shape. The syringe connection port 10 may be configured for releasably connecting to a syringe adaptor. The syringe adaptor may comprise a syringe adaptor body generally shaped as a sleeve. The syringe connection port 10 may for example be configured for said tubular member to be inserted in said sleeve. For example, said tubular member may be slid inside the sleeve via an open end of said sleeve. The syringe adaptor may comprise a hollow needle extending inside the sleeve from a base element closing the other end of the sleeve. The nozzle of a syringe may be mounted on a syringe mounting port of the syringe adaptor in fluid communication with the hollow needle. The syringe mounting port may be formed on a side of the base element opposite to a side from which the needle extends. The syringe mounting port may be configured for the direct mounting of a nozzle of the syringe. The nozzle of the syringe may be of a non-needle type, for example of a luer type, and/or formed in a non-metallic material, for example in plastic. The syringe adaptor may thus allow using components which do not present any protuberant metallic needle.

In such examples, the syringe adaptor may optionally further comprise a cork arranged in the sleeve so as to enclose a space inside the sleeve that comprises the hollow needle. The cork may be a plug or a stopper. The cork may isolate the needle. The cork may close the needle aperture (so that a user cannot push the syringe plunger when the syringe adaptor is not connected). The cork may in examples be a (e.g. single and/or massive) septum. The cork may, in examples, comprise two septa enclosing a volume of air (the aperture of the needle in the rest position is at a location within the cork—in particular in the middle “air” portion). Other examples of a cork may include a distal disk septum and a sleeve septum which closes the needle aperture or distal disk septum only. Such cork improves safety of use.

The cork may comprise a septum. The septum of the syringe adaptor may present any feature or combination of features of any example of the septum 12 of vial adaptor 1. The cork may be mobile and configured to slide inside the sleeve upon the tubular member of the vial adaptor 1 being itself slid inside the sleeve. The tubular member may reach the cork and impart sliding to the cork, such that the hollow needle of the syringe adaptor comes out of the enclosed space through the septum of the syringe adaptor, said hollow needle then further piercing the septum 12 of the vial adaptor 1 as the cork and the tubular member continue to be slid inside the sleeve. The tip of the hollow needle may initially be planted inside the septum 12 before the syringe adaptor is mounted on the vial adaptor 1. The tip of the hollow needle may alternatively initially be arranged inside the enclosed space. This at least reduces contamination risks of said tip of the hollow needle. The syringe adaptor may further comprise a spring element configured for the cork to slide in the sleeve back to its initial position when the syringe adaptor is dismounted from the vial adaptor 1. The spring element may be a compressible spring linking the cork and the base element, thereby biasing the cork distally.

In examples, the syringe connection port 10 (e.g. the tubular member) may optionally comprise a structure configured for the mounting of the syringe adaptor thereon to be performed via attachment, for example via snapping. Such structure may comprise recess(es)—or respectively clamp(s)—configured for cooperating with corresponding clamp(s)—or respectively recess(es)—of the syringe adaptor. The syringe adaptor may comprise handles configured to control said clamp(s) or recess(es) of the syringe adaptor so as to perform unsnapping, e.g. manually.

The vial connection port 20 is a part of the vial adaptor 1 that is configured for connection, e.g. releasable connection, to a vial. The vial connection port 20 may be configured for connection of the vial adaptor 1 to any one or more types of vial. A vial is a recipient or bottle containing or configured for containing any type of medical substance. The vial adaptor may be configured for use with any one or more types of vial, for example with vials containing a drug substance powder. The materials and processes used for manufacturing the vial adaptor may thereby be appropriate for such use. The vial may be provided with the substance contained in fluid form (e.g. as a liquid), or in a soluble solid form (e.g. as a powder). A vial may comprise a vial neck configured for mounting a vial connection port of a vial adaptor thereon, and a container portion configured for containing the substance.

The vial neck may, as known in the art, comprise a cap mounted on a container neck arranged at one extremity of the container portion. The container neck may be integrally formed with the container portion. The container neck and/or the container portion may be made of a rigid or semi-rigid material, for example glass or plastic. The container portion may present a tubular shape. The container neck and/or the vial neck may present a tubular shape. The container neck may comprise an opening sealed with the cap. The cap may integrate a septum. The cap may for example comprise a casing. The casing may comprise a skirt portion configured for mounting and airtightly attaching the cap on the container neck and a substantially plane portion defining the top of the cap and presenting an aperture filled by the septum. The casing may maintain firmly the septum so as to close airtightly the aperture. The aperture and correspondingly the septum may present a generally disk shape and/or be located at the center of the top of the cap. The casing may be made of a rigid or semi-rigid material, for example metal (such as aluminum) or plastic. The skirt portion may present a shape complementary to the container neck, for example a tubular shape. The skirt portion may comprise a thread configured for thread-fitting the cap on a corresponding thread of the container neck. Alternatively, the skirt portion may be configured for crimping the container neck airtightly. The container neck may for example comprise a circumferential bead forming a peripheral protuberance and the skirt portion may be metallic (e.g. in aluminum) and crimped on the bead. The cap may further comprise a removable cover configured for protecting the septum and detachable before use of the vial.

The vial connection port 20 may be configured for a direct connection and/or an indirect connection. In the direct connection case, the vial connection port 20 may be mounted directly on the vial. This simplifies the assembly. In the indirect connection case, the connection may be performed for example via an intermediate element mounted on the vial, such as a vial converter. This allows using the same vial adaptor 1 for connection to different types of vials. The vial converter may be mounted on the vial neck. A vial converter may notably allow using the same vial adaptor 1 for different vial neck diameters, including diameters out of the range of a direct mounting of the vial connection port 20. A same vial connection port 20 may be configured for both the direct type of connection and the indirect type of connection.

The vial connection port 20 may define a vial connection axis. The mounting of the vial adaptor 1 on a vial neck or on a vial converter may include a relative translational movement between the vial adaptor 1 and the vial neck along said vial connection axis. The vial connection axis may be an axis along which the vial neck extends during the mounting, for example a central longitudinal and straight axis of the vial neck.

The vial connection port 20 comprises a skirt 220, as previously discussed. The skirt 220 forms a docking structure configured for the mounting on the vial or vial converter to be performed via attachment, for example via snapping. The skirt 220 may notably comprise clamp(s) and/or recess(es) configured for cooperating with corresponding structure of the vial or vial converter, for example the vial neck. The attachment and/or snapping may be performed by pressing the skirt 220 of the vial adaptor 1 onto the corresponding structure of the vial or vial converter along the vial connection axis. As previously discussed, the skirt 220 may be integrally formed with the rest of the vial adaptor body, i.e. the conduit portions, the casing portion, and the syringe connection port 10. Alternatively, as previously discussed, the skirt 220 may be releasably connected to (e.g. threaded with) the rest of the vial adaptor body.

The vial connection axis may be the central axis of the skirt 220. The skirt 220 may present a shape adapted to the vial neck or vial converter, such that the vial neck or vial converter may be inserted inside the skirt 220 along the central axis of the skirt 220, for example press-fitted inside the skirt 220. The skirt 220 may comprise one or more peripheral walls extending in a direction at least substantially parallel to the central axis of the skirt and bounding the skirt 220. The one or more peripheral walls may be configured for accommodating the vial neck or vial converter. The one or more peripheral walls may be configured for being fitted to the vial neck or vial converter. This allows the skirt 220 to encase the vial neck or vial converter and thus provides an easy and stable mounting of the vial adaptor 1. The skirt 220 may present a generally prism (cylindrical) shape. The vial connection port 20 may in examples comprise a single peripheral wall delimiting the skirt 220 and presenting a rim delimiting entry of the skirt 220. In alternative examples, the vial connection port 20 may comprise several peripheral walls forming legs delimiting the skirt 220.

The skirt 220 may present a diameter (i.e. largest dimension in a plane perpendicular to the central axis of the skirt) higher than the diameter of the vial neck or vial converter. The diameter of the skirt 220 may for example be higher than the diameter of the cap of the vial. The skirt 220 may be further shaped for the vial neck to be radially stable when inserted inside the skirt 220. The skirt 220 may correspond to any standard provided for vials used in the medical industry.

The vial connection port 20 may comprise a system for retaining the vial after connection to the vial, for example after insertion of the vial neck or vial converter inside the skirt 220. The vial adaptor 1 may be configured for connection of the vial connection port 20 to the vial by pushing the vial adaptor 1 onto the vial neck or vial converter such that the vial neck or vial converter is pressed and snapped inside the skirt 220. One or more peripheral walls of the skirt 220 may for example comprise clamps extending inwardly toward the central axis of the skirt 220. The diameter of the portion of the skirt 220 bounded by the clamps may be smaller than the diameter of the cap of the vial or top part of the vial converter. The one or more peripheral walls of the skirt 220 may present at least slight elasticity. The clamps may be configured for abutting the bottom edge of the skirt portion of the cap of the vial or top part of the vial converter after snapping, thereby acting as a system for retaining the vial.

The vial connection port 20 further comprises a spike 230 forming a piercing member. The spike 230 may be integrally formed and may be integrally formed with the skirt 220. The skirt 220 and the spike 230 may also be integrally formed with the rest of the vial adaptor body as previously discussed, or, alternatively, releasably connected to (e.g. threaded with) it. The spike 230 has a pointed tip 232 configured for piercing the septum of the vial when the vial connection port 20 is mounted on the vial neck. The septum of the vial may for example comprise an elastomeric material. The elastomeric material may be configured for deforming when punctured by the spike 230 in such a way that the spike 230 can pierce through the septum and the elastomeric material forms a at least substantially airtight seal around the spike 230. The elastomeric material may for example comprise rubber, such as silicone rubber and/or butyl rubber. The spike 230 may have a length configured for the pointed tip 232 of the spike 230 to go beyond the septum and be inside the vial when the vial connection port is mounted on the vial neck or vial converter.

The spike 230 may for example extend in the skirt 220 in a direction parallel to the central axis of the skirt 220, for example from the bottom face of the skirt 220 and toward the vial. The spike 2230 may for example extend substantially from the center of the bottom face of the skirt 220 and/or substantially along the central axis of the skirt 220.

The spike 230 may comprise a pointed tip 232. The spike 230 may be rigid or semi-rigid. For example, the spike 230 may be made of metal. The spike 230 may be formed of a material that is resistant to the vehicle and solvent. The spike 230 may be integrally formed and/or in the same material as the body portion of the vial connection port 20, for example in plastic. The spike 230 may alternatively or additionally comprise one or more needles. The needle(s) may be metallic. The needle(s) may be integrated into the vial adaptor body, for example integrally formed with the vial adaptor body. For example, the needle may be integrated in the vial adaptor 1 and protruding out of the vial adaptor body into the skirt 220 of the vial connection port 20. In examples, the spike 230 embeds (i.e. coats) one or more (e.g. metallic) needle(s). A needle may be relatively easy to manufacture, for example relative to a thin hollow spike.

Alternatively or additionally to such spike, the vial connection port 20 may comprise one or more orifices configured for passage of a separate piercing component, such as a hollow needle. The one or more orifices may in examples be formed on a surface of the vial connection port 20 facing the vial, e.g. on the bottom face of the skirt 220 of the vial connection port 20, and/or aside the spike 230.

The spike 230 comprises a lumen forming a fluid channel. The lumen connects to (e.g. forms, when the spike 230 is integrally formed with the rest of the vial adaptor body) a lower extremity portion of the conduit (relative to the vial adaptor 1 considered in a horizontal plane, as in FIGS. 1 and 2). Thereby, upon connection of the vial connection port 20 with a vial, fluid may flow between the vial and the conduit through the fluid channel. In other words, this lower extremity portion forms an opening on the tip of the spike 230 so as to allow fluid communication between the conduit and the vial when the spike 230 has pierced the septum of the vial. The pointed tip 232 of the spike 230 and thereby the openings may indeed be inside the vial at that time.

The central axis of the skirt 220 may be the central axis of the vial adaptor body that is the vial connection axis. The spike 230 may extend at least substantially parallel to and/or along the central axis of the skirt 220. The syringe connection port 10 may comprise an opening as earlier-described. The opening may be formed on the tip of a tubular member of the vial adaptor 1 as earlier-described. The central axis of the opening and/or of the tubular member may be the central axis of the vial adaptor body. The conduit may extend at least substantially along the central axis of the vial adaptor body, for example between the opening of the syringe connection port 10 and the pointed tip 232 of the spike 220. The skirt 220 and the opening may be oriented in opposite directions of the central axis of the vial adaptor body. The vial adaptor body thereby allows mounting the vial adaptor 1 on a vial neck or vial converter by plugging the vial neck or vial converter inside the docking structure along the central axis of the vial adaptor body, and (e.g. then) mounting the syringe adaptor on the syringe connection port 10 along the same central axis of the vial adaptor body. The syringe adaptor may be mounted on the syringe connection port 10 after or before the syringe adaptor is assembled to a syringe.

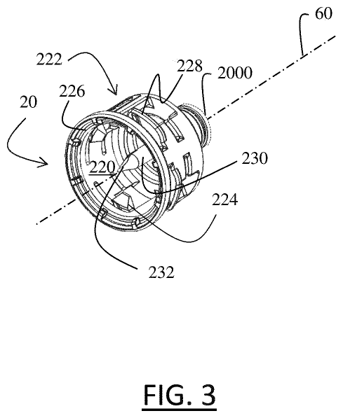

An example of the vial connection port is now further discussed with reference to FIG. 3, which shows an example of the vial connection port, such as the vial connection port 20 discussed earlier with reference to FIGS. 1-2. The rest of the vial adaptor 1 is not shown in FIG. 3. Specifically, FIG. 3 shows a partial view of the vial adaptor 1, the vial adaptor 1 being cut along curved dotted line 2000: the part of the vial adaptor 1 downward the dotted line 2000 relative to an horizontal plane (as in FIGS. 1-2), namely the vial connection port 20, is shown on FIG. 3, while the rest of the vial adaptor 1 (including the conduit 30, the valve 40 and the syringe connection port 10, and for example the casing portion), upward the dotted line 2000, is not shown on FIG. 3. The vial connection port 20 comprises a skirt 220 centered on the central axis 60, previously discussed. The vial connection port 20 further comprises an integrally formed spike 230 extending along the axis 60. The spike 230 comprises a pointed tip 232 for piercing a vial septum. The skirt 220 comprises a peripheral wall 222 extending substantially parallel to the axis 60. The wall 222 delimits the skirt 220 and presents a rim 226 delimiting entry of the skirt 220. The skirt 220 presents a generally cylindrical shape. The wall 222 comprises clamps 224 extending inwardly toward the axis 60 and configured for attaching and/or snapping the vial neck or vial converter inside the skirt 220. The wall 222 further presents radially traversing recesses 228 which facilitate the snapping. Other configurations may be contemplated. For example, the body portion may comprise several peripheral walls forming legs delimiting the skirt and no rim.

It is further provided a method of use of the vial adaptor 1. The steps of the method may be carried out by one or more users.

The method of use comprises providing a vial containing a drug (e.g. in a powder form) and a syringe comprising a reconstitution fluid. The reconstitution fluid may include a solvent (e.g. an aggressive solvent) and/or a vehicle. The syringe may additionally or alternatively comprise a drug, e.g. a drug different from the drug contained in the vial. The vehicle may comprise a solution of polymers and or copolymers, the polymers and copolymers comprising for example poly(lactide), poly(glycolide), poly(lactide-co-glycolide), poly-1-lactic acid, poly-d-lactic acid, poly(glycolic acid), copolymers of the foregoing, poly(aliphatic carboxylic acids), poloxamers, polycaprolactone, polydioxanone, poly(ortho carbonates), poly(acetals), poly(lactic acid-caprolactone), polyorthoesters, poly(glycolic acid-captolactone), poly(amino acid), polyesteramide, polyanhydrides, polyphosphazines, poly(alkylene alkylate), biodegradable polyurethane, polyvinylpyrrolidone, polyalkanoic acid, polyethylene glycol (PEG), copolymers of PEG and polyester or polyorthoester, albumin, chitosan, casein, waxes or blends or copolymers thereof. The providing of the vial may comprise (pre-)filling the syringe with the reconstitution fluid, for example by filing it with the solvent and/or the vehicle, and/or filling the vial with the drug (e.g. in powder form). The drug may include one or more active pharmaceutical ingredient such as a hormone (for contraception, cancer treatment) antipsychotic, e.g. olanzapine, risperidone, aripiprazole, paliperidone, or lurasidone or a pharmaceutically acceptable salt thereof, or any API for which premixing of the API with a solution is undesired or deleterious. The reconstitution fluid may be configured for being mixed with the drug in the vial. Additionally, the reconstitution fluid, when mixed with the drug and injected (e.g. intramuscularly or subcutaneously), may be configured to form a bioresorbable depot (e.g. intramuscular or subcutaneous). The solvent may include a hydrophilic solvent such as DMSO, in which case the material of the vial adaptor is adapted for being in contact with such an aggressive solvent. For example, the vial adaptor may be formed in polypropylene, as previously discussed. Other plastics which are compatible with DMSO and in which the vial adaptor may be formed also include PETE, HDPE, LDPE or PTFE. An aggressive solvent is a solvent that may damage (e.g. dissolve, melt) one or more components of a vial adaptor. In some embodiments a mixture of solvents may be desired. Non-limiting list of biocompatible solvents includes DMSO, N-methyl-2-pyrrolidone (NMP), 2-pyrrolidone (2P), triacetin (TA) and benzyl benzoate (BB).

The method of use further comprises connecting the vial adaptor to the vial and connecting the syringe to the vial adaptor. The connection between the vial adaptor and the vial may be performed in any manner previously discussed when discussing the vial connection port. Likewise, the connection between the syringe and the vial adaptor may be performed in any manner previously described when discussing the syringe connection port. The respective connections between the vial and the vial adaptor and between the vial adaptor and the syringe may be performed in any order. Prior to these connections, the method may comprise sealing the conduit by operating the valve, e.g. by rotating the valve to the second position.

The method of use then comprises selectively blocking and allowing fluid flow between the syringe and the vial by operation of the syringe and operation of the valve. Selectively blocking and allowing fluid flow may comprise operating the valve in order to seal the conduit, i.e. to block fluid flow through the syringe connection port, e.g. by rotating the valve in the second position, and/or maintaining the valve in such an arrangement. Alternatively or subsequently, selectively blocking and allowing fluid flow may comprise verifying whether the valve allows fluid flow through the syringe connection port, for example by verifying whether the valve is in the first position, and/or operating the valve to allow fluid flow through the syringe connection port, e.g. by rotating the valve into the first position.

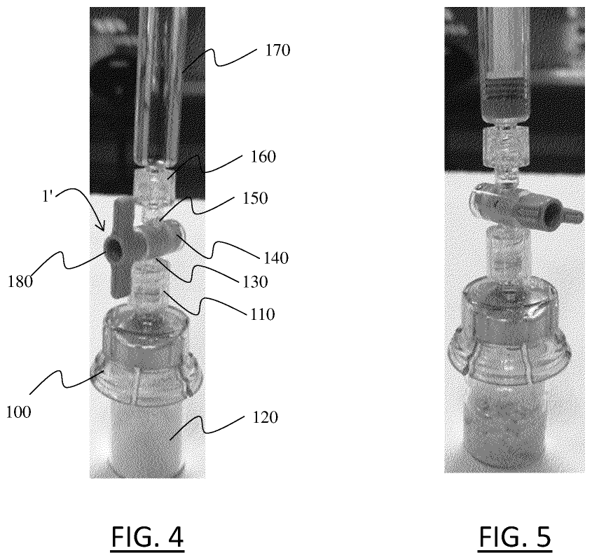

Examples of the method of use are now discussed with reference to FIGS. 4 to 8, which shows a vial adaptor in line with the example of FIGS. 1 and 2. In this example, the vial adaptor body comprises two integrally formed components which are coupled to each other via a twist fit threading coupling (luer lock mechanism), an integrally-formed component including a syringe connection port, a casing portion and a conduit, another integrally-formed component including a skirt and a spike. But the discussion applies to the alternative example where the vial adaptor body consists in a single integrally-formed component, the skirt and the spike being integrally-formed with the rest of the vial adaptor body. The discussion also applies to the alternative example where the two integrally-formed components are assembled in any other manner than with a threaded engagement, for example if they are assembled by press-fitting.

FIG. 4 illustrates the method after the connections between a syringe 170, a vial 120 and a vial adaptor 1′ have been performed. Vial adaptor 1′ and its constituent components may share similar features/elements with vial adaptor 1, which will not be discussed here for brevity.

In the example of FIG. 4, the vial adaptor 1′ comprises a vial adaptor body made of two integrally-formed components which are coupled together using a twist fit thread coupling mechanism, such as a luer lock coupling. In other words, the two integrally-formed components are threaded together. The first integrally-formed component includes a syringe connection port, a first conduit portion, a casing portion and a second conduit portion. The second integrally-formed component includes a vial connection port, including a skirt and a spike. The first integrally-formed component has a generally linear and straight shape and includes several tubular portions (e.g. of a general cylindrical shape).

The first integrally-formed component includes tubular portion 160, which forms the syringe connection port, configured for connection of a syringe, such as syringe 170. Tubular portion 160 comprises a lumen. The first integrally-formed component further includes tubular portion 150, aligned with tubular portion 160. Tubular portion 150 comprises a lumen connected to the lumen of tubular portion 160, the lumen of tubular portion 150 forming the first conduit portion. The first integrally-formed component further includes a hollow portion 140, which forms a casing for a valve 180. Hollow portion 140 may be cylindrical and perpendicular to tubular portion 150.

Valve 180 is tightly inserted (e.g. press-fitted) in hollow portion 140. In other words, the valve body has a shape substantially complementary to the inside of hollow portion 140. In the example shown in FIG. 4, valve 180 comprises a handle integrally-formed with the valve body.

The first integrally-formed component further includes tubular portion 130 aligned with tubular portion 150. Tubular portion 130 comprises a lumen forming the second conduit portion. Valve 180 is manually operable between a first position allowing fluid flow from the syringe 170 into the vial adaptor through tubular portion 160 (such that fluid can flow from the syringe 170 into tubular portion 130, i.e. downstream the valve 180), and a second position where such fluid flow through tubular portion 160 is blocked even if the syringe 170 is connected to the tubular portion 160 (such that fluid cannot flow or is stopped from flowing from the syringe 170 into tubular portion 130, i.e. downstream the valve 180).

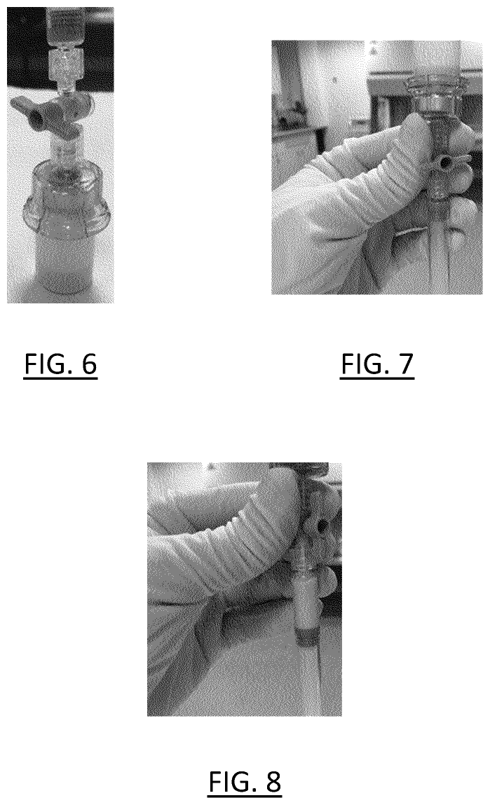

Valve 180 is shown in the first position in FIG. 4. In the first position, a fluid passageway formed in the valve body connects the lumen of portion 150, i.e. the first conduit portion, with the lumen of portion 130, i.e. the second conduit portion. Thus, the lumens of tubular portions 160, 150 and 130, and the fluid passageway of valve 180, form a fluid channel between syringe 170 and a lumen of the spike. Fluid is thus allowed to flow from the syringe and into the lumen of the spike in this position. Such fluid flow is blocked, and no more allowed, once the valve is rotated in the second position, as shown in FIGS. 5-6, discussed hereinbelow.

The first integrally-formed component further includes a tubular portion 110, aligned with tubular portion 130. Tubular portion 110 is coupled with the second integrally-formed component, which includes a skirt 100. Specifically, an upper tip of skirt 100 is coupled with tubular portion 110, e.g. threaded with tubular portion 110, for example using a twist fit threading coupling mechanism such as a luer lock coupling. The skirt 100 is configured to attach the vial adaptor to 1′ to a vial, such as vial 120. Skirt 100 includes the spike having a lumen, the lumen being connected to the lumen of tubular portion 130, i.e. the second conduit portion, for example by means of a lumen of tubular portion 110 connecting the lumen of the spike to the lumen of tubular portion 130. Skirt 100 has an axial symmetry of revolution around the vial connection axis.

The selective blocking and allowing of fluid flow between the syringe 170 and the vial 120 may comprise dispensing reconstitution fluid from the syringe 170 inside the vial 120 for reconstitution of a solution inside the vial 120. The valve 180 allows fluid flow during the dispensing. Previous to the dispensing, the selective blocking and allowing may comprise verifying whether the valve 180 is in the first position and/or rotating the valve 180 into the first position. The dispensing may comprise, the valve 180 allowing fluid flow (e.g. being in the first position), operating the syringe 170, e.g. by pushing a plunger of the syringe 170 toward the distal direction, to expel (e.g. all) the reconstitution fluid through the syringe connection port, the conduit and the vial connection port, and ultimately into the vial 120. The reconstitution fluid dispensing goes smoothly, and overpressure is building up inside the vial 120 during dispensing. The selective blocking and allowing of fluid flow then comprises operating the valve to block fluid flow after the dispensing, e.g. by rotating the valve 180 into the second position. This notably prevents plunger push back in the syringe 170, as previously discussed. The method of use may further comprise, after the operating to block fluid flow, manually agitating (e.g. shaking) the vial 120, as further discussed in examples hereinafter.

FIG. 5 illustrates the method a few moments after the step shown in FIG. 4. In FIG. 5, the reconstitution fluid has been completely expelled from the syringe 170 and into the vial 120. The valve 180 is being rotated into the second position, to block fluid flow after the dispensing. The rotation of the valve toward the second position results in that the fluid passageway of the valve 180 is not aligned with the first and second conduit portions, as it were in FIG. 4.

The method may then comprise performing reconstitution of a powder, e.g. a drug, inside the vial 120. The performing of the reconstitution occurs while the valve 180 blocks fluid flow and may be carried out at least partly by a user. The performing of the reconstitution may comprise mixing the reconstitution fluid and the drug. The mixing may comprise, by a user, tapping the vial 120, e.g. for about two minutes, and manually agitating (e.g. shaking) the vial 120 to finish reconstitution, e.g. for about thirty seconds. In some embodiments, manually agitating (e.g. shaking) may be prolonged and/or vigorous in order to adequately mix the reconstitution fluid with the drug. This yields a partially or fully reconstituted solution comprising the reconstitution fluid and/or vehicle mixed with the drug. The tapping and/or the manually agitating (e.g. shaking) can occur while the syringe 170 is connected to the syringe connection port, the valve 180 being in the second position which ensures that there is no accidental withdrawing into the syringe 170 while tapping and/or manually agitating (e.g. shaking) and/or no accidental plunger push back. The manually agitating (e.g. shaking) may alternatively occur while the syringe 170 is detached. The method may result in, for example, a reconstituted solution or a dispersion of reconstitution fluid and drug.

FIG. 6 illustrates the method a few moments after FIG. 5, wherein reconstitution has been achieved. The valve 180 still blocks fluid flow in FIG. 6, i.e. the fluid passageway of the valve 180 is still not aligned with the first and second conduit portions.

The method may then further comprise operating the valve 180 to allow fluid flow, for example by rotating the valve 180 from the second position to the first position. Prior to that, the method may comprise turning over the assembly made of the vial 120, the vial adaptor 1′ and the syringe 170, as shown in FIG. 7. After operating the valve 120 to allow fluid flow, the method then comprises withdrawing the reconstituted solution inside the vial 120 with a withdrawal syringe 170. In other words, the withdrawal may be carried out with the syringe 170 that originally contained the reconstitution fluid, or alternatively, with another syringe. In the latter alternative, the method of use may comprise disconnecting the syringe that contained the reconstitution fluid and connecting another syringe to the syringe connection port. The withdrawal may comprise operating the withdrawal syringe of choice, e.g. by pulling a plunger of the syringe (resp. the other syringe) toward a proximal direction. Notably, overpressure earlier built and trapped in the vial contributes to a smooth withdrawal. FIG. 8 illustrates the withdrawal, the valve 180 having been rotated back into the first position in FIG. 8. The withdrawal may include additionally transferring reconstituted solution into the vial 120 and back to the syringe of choice. This avoids, or at least reduces, formation of pure reconstitution fluid and air mixture remaining on a distal top of the withdrawal syringe.

The method may then comprise disconnecting the withdrawal syringe (from the vial adaptor 1′ and performing an injection of the reconstituted solution with the same syringe, as known in the art. The injection may be performed after an appropriate needle is attached the syringe. The injection may for example be an intramuscular or subcutaneous injection. The skilled healthcare profession is familiar with these steps.

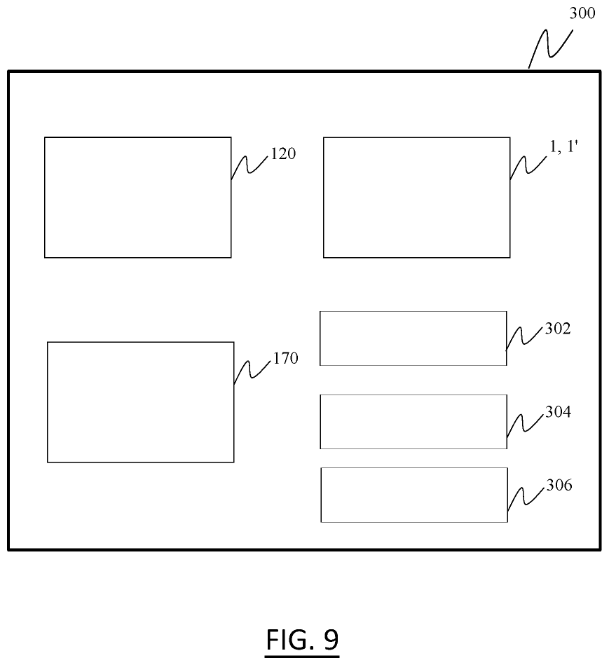

Referring to FIG. 9, a kit 300 according to an embodiment of the current disclosure is schematically illustrated. The kit 300 comprises a vial, such as vial 120 containing a drug. The kit 300 comprises a syringe, such as syringe 170, comprising a reconstitution fluid. The syringe 170 is capable of cooperating with the vial adaptor 1, 1′. The reconstitution fluid may comprise a solvent and/or a vehicle. The syringe 170 may additionally or alternatively comprise a drug, e.g. a drug different from the drug contained in the vial 120. The kit 300 may optionally comprise a syringe adaptor 302 and/or a needle 304 for injection. The syringe adaptor 302 may be configured to cooperate with the vial adaptor 1, 1′. The syringe adaptor 302 may for example be configured to be connected to the syringe connection port of the vial adaptor 1, 1′. The syringe 170 may enable fluid mixing. The kit 300 may additionally or alternatively comprise instructions 306 for a user. The syringe 170 in the kit 300 may contain DMSO and polymers. The vial 120 may contain (e.g. only) an API e.g. olanzapine powder. The kit 300 may further comprise another syringe and or additional needle for performing a withdrawal or administration.

The invention illustratively described herein suitably may be practiced in the absence of any element(s) not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. For the foregoing embodiments, each embodiment disclosed herein is contemplated as being applicable to each of the other disclosed embodiments. For instance, the elements recited in the device embodiments can be used in the kit and use embodiments described herein and vice versa.

What is claimed is:

1. A vial adaptor comprising:
a syringe connection port configured to be connected to a syringe,
a vial connection port, the vial connection port comprising a skirt and a spike, the spike comprising a lumen forming a fluid channel,
a conduit configured to provide fluid flow between the syringe connection port and the vial connection port, wherein the syringe connection port and the vial connection port are arranged on opposite sides of the vial adaptor, and wherein the conduit is linear or straight;
a valve for selectively blocking and allowing fluid flow between the syringe and the vial connection port when the syringe is connected to the syringe connection port.

2. (canceled)

3. The vial adaptor of claim 1, wherein the valve comprises a valve body and a fluid passageway formed in the valve body, the valve being operable between a first position in which the fluid passageway is aligned with the conduit and allows fluid flow, and a second position in which the valve body blocks fluid flow.

4. The vial adaptor of claim 3, wherein the valve is movable in rotation between the first position and the second position, and/or wherein the fluid passageway formed in the valve body has a diameter smaller than a diameter of the conduit.

5. The vial adaptor of claim 3, wherein the valve comprises a handle for manually operating the valve between the first position and the second position, the handle being integrally formed with the valve body.

6. The vial adaptor of claim 3, wherein the valve is operable between the first position and the second position independent of a syringe being connected to the syringe connection port.

7. The vial adaptor of claim 3, wherein the vial adaptor further comprises a casing portion, the valve body being arranged in the casing portion, wherein the casing portion has a cylindrical shape, the valve body having a cylindrical shape complementary to the cylindrical shape of the casing portion, the valve body being movable in rotation between the first position and the second position around a longitudinal axis of the casing portion.

8. The vial adaptor of claim 7, wherein the longitudinal axis of the casing portion is substantially orthogonal to a vial connection axis of the vial adaptor defined between the syringe connection port and the vial connection port.

9. The vial adaptor of claim 7, wherein the vial adaptor comprises a first conduit portion in fluid communication with the syringe connection port, a second conduit portion in fluid communication with the vial connection port, the casing portion being arranged between the first conduit portion and the second conduit portion.

10. The vial adaptor of claim 9, wherein the syringe connection port, the first conduit portion, the casing portion and the second conduit portion are integrally formed.

11. The vial adaptor of claim 9, wherein:
the skirt and the spike are integrally formed with the second conduit portion, or
the skirt and the spike are releasably connected to the second conduit portion.

12. The vial adaptor of claim 10, wherein the vial adaptor is configured for releasable connection to a syringe or to a syringe adaptor, the syringe connection port comprising a luer lock.

13. The vial adaptor of claim 1, wherein the vial adaptor is manufactured from a material resistant to an aggressive solvent.

14. The vial adaptor of claim 1, further comprising a filter disposed in the conduit.

15. The vial adaptor of claim 1, further comprising a septum configured to seal the conduit.

16. A method of use of a vial adaptor comprising:
providing a vial containing a drug and a syringe comprising a reconstitution fluid, the reconstitution fluid comprising a solvent or a vehicle;
connecting a vial adaptor to a vial, wherein the vial adaptor comprises a syringe connection port configured to be connected to a syringe, a vial connection port comprising a skirt and a spike, the spike comprising a lumen forming a fluid channel, a conduit configured to provide fluid flow between the syringe connection port and the vial connection port, wherein the syringe connection port and the vial connection port are arranged on opposite sides of the vial adaptor, and wherein the conduit is linear or straight, and a valve for selectively blocking and allowing fluid flow between the syringe and the vial connection port when the syringe is connected to the syringe connection port;
connecting the syringe to the vial adaptor;
selectively blocking and allowing fluid flow between the syringe and the vial by operation of the syringe and operation of the valve.

17. The method of claim 16, wherein the selective blocking and allowing of fluid flow between the syringe and the vial comprises:
dispensing reconstitution fluid from the syringe inside the vial for reconstitution of a solution inside the vial, the valve allowing fluid flow during the dispensing;
operating the valve to block fluid flow after the dispensing; and:
manually agitating the vial after the operating to block fluid flow.

18. The method of claim 17, wherein the method further comprises after reconstitution:
operating the valve to allow fluid flow; and
withdrawing the reconstituted solution inside the vial with the syringe or with another syringe;
and, after the withdrawing:
disconnecting the syringe or the other syringe from the vial adaptor; and
performing an injection of the reconstituted solution with the syringe or the other syringe, the injection being a subcutaneous injection.

19. (canceled)

20. A system comprising:
a vial comprising a drug;
a syringe comprising a reconstitution fluid capable of cooperating with the vial adaptor; and
a vial adaptor, the vial adaptor comprising:
a syringe connection port configured to be connected to a syringe,
a vial connection port, the vial connection port comprising a skirt and a spike, the spike comprising a lumen forming a fluid channel,
a conduit configured to provide fluid flow between the syringe connection port and the vial connection port, wherein the syringe connection port and the vial connection port are arranged on opposite sides of the vial adaptor, and wherein the conduit is linear or straight;
a valve for selectively blocking and allowing fluid flow between the syringe and the vial connection port when the syringe is connected to the syringe connection port.

21. The system of claim 20, further comprising:
another syringe or needle for performing an injection or administration.

22. The system of claim 20, wherein the valve comprises a valve body and a fluid passageway formed in the valve body, the valve being operable between a first position in which the fluid passageway is aligned with the conduit and allows fluid flow, and a second position in which the valve body blocks fluid flow
